(19) United States
(12) Patent Application Publication
(10) Pub. No.: US 2026/0197628 A1
(43) Pub. Date: Jul. 9, 2026

(54) Electronic Devices and Corresponding Methods for Transferring Embedded Subscriber Identity Modules (eSIMs) Among Linked Family Devices as a Fuction of Location

(71) Applicant: Motorola Mobility LLC, Chicago, IL (US)

(72) Inventors: Amit Kumar Agrawal, Bangalore (IN); Panduranga Reddy Pailla, Nalgonda (IN); Shuaib Puzhakkal Kavalathara, Karnataka (IN)

(21) Appl. No.: 19/013,963

(22) Filed: Jan. 8, 2025

(51) Int. Cl. H04W 8/20; H04W 12/06; H04W 12/72; H04W 64/00

(52) U.S. Cl. CPC H04W 8/205; H04W 12/06; H04W 12/72; H04W 64/00

(57) ABSTRACT

A method in an electronic communication device involves determining, by one or more processors, that a communication device is operable with an embedded subscriber identity module (eSIM) having at least a first profile associated with the electronic communication device and at least a second profile associated with a second electronic communication device while the eSIM operates with the first profile in a trusted location. The method includes determining that the second electronic communication device is departing the trusted location. In response, the method performs a transfer of the eSIM from the electronic communication device to the second electronic communication device. This process ensures seamless communication and network access for the second electronic communication device as the second electronic communication device moves away from the trusted location, dynamically managing eSIM profiles among linked family devices.

### BACKGROUND

### Technical Field

This disclosure relates generally to electronic communication devices, and more particularly to electronic communication devices using embedded subscriber identity modules (eSIMs).

### Background Art

The adoption of digital modules for managing mobile network connections has increased flexibility and convenience. Unlike traditional physical modules, digital modules are embedded directly into the hardware, allowing for digital activation and management without the need for physical removal or swapping.

Managing these digital modules among multiple devices within a family setting presents several challenges. The current process to switch between devices involves multiple steps, often requiring physical tools or assistance from service providers. This complexity becomes a significant barrier for less tech-savvy consumers, making the process time-consuming and cumbersome. It would be advantageous to have improved electronic devices and corresponding methods for simplifying the use of digital modules.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates another explanatory method in accordance with one or more embodiments of the disclosure.

FIG. 5 illustrates one or more method steps in accordance with one or more embodiments of the disclosure.

FIG. 6 illustrates one or more method steps in accordance with one or more embodiments of the disclosure.

FIG. 7 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, by one or more processors of the electronic communication device, that a communication device of the electronic device is operable with an embedded subscriber identity module (eSIM) having at least a first profile associated with the electronic communication device and at least a second profile associated with at least a second electronic communication device while the eSIM is operating with the first profile in a trusted location, determining, by the one or more processors from signals received by the communication device from the second electronic communication device, that the second electronic communication device is departing the trusted location, and performing, in response to the second electronic communication device departing the trusted location, a transfer of the eSIM from the electronic communication device to the second electronic communication device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in an electronic device comprising a communication device operable with an eSIM having at least a first profile associated with the electronic communication device and at least a second profile associated with at least a second electronic communication device and one or more processors operable with the communication device, and in response to detection of a trusted location departure event, initiating a transfer of the eSIM from the second electronic communication device to the electronic communication device as described herein. The non-processor circuits may include, but are not limited to, a radio receiver, a radio transmitter, signal drivers, clock circuits, power source circuits, and user input devices.

As such, these functions may be interpreted as steps of a method to perform detecting, by one or more processors of the electronic communication device, that a communication device of the electronic device is operable with an eSIM having at least a first profile associated with another electronic communication device and at least a second profile associated with the electronic communication device while the eSIM is operating with the first profile in a trusted location, determining, by the one or more processors, that the electronic communication device is departing the trusted location, and initiating, in response to the electronic communication device departing the trusted location, a transfer of the eSIM from the another electronic communication device to the electronic communication device. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, the adoption of digital modules for managing mobile network connections has increased flexibility and convenience by embedding devices such as eSIMS directly into the hardware, thereby allowing for digital activation and management without the need to physically remove and swap a card. At the same time, managing these digital modules among multiple devices within a family setting presents several challenges as switching between devices involves multiple steps and generally requires specialized tools or assistance from a technical professional. This complexity becomes makes the process time-consuming, expensive, and cumbersome.

Embodiments of the disclosure contemplate that in family environments, parents often face difficulties in tracking and communicating with their children when they leave trusted locations such as home. To address this, some parents resort to purchasing separate digital modules for each child. Clearly, this redundancy leads to increased costs and the inconvenience associated with manually switching modules. Embodiments of the disclosure contemplate there is thus a need for a streamlined and efficient method to manage digital modules among linked family devices. This is particularly true in scenarios where multiple family members require access to mobile network services on demand.

Illustrating by example, some hardware manufacturers have introduced family networking services that allow a group of electronic devices to be linked together in a family group. For instance, Motorola Mobility.sup.TM has introduced “Family Space 3.0,” which is a system designed to enhance family safety and monitoring by providing tools and features that help users keep track of their loved ones. The system includes several functionalities aimed at simplifying and improving the user experience within a family setting.

Family Space 3.0 offers a subscription plan that includes additional features such as screen time management and location tracking. These features help parents monitor and control the amount of time their children spend on devices and keep track of their locations.

The system elevates the experience and controls when adding Motorola.sup.TM devices to the family hub. This integration is facilitated through “DO-ThinkShield,” a security platform that ensures the safety and privacy of the devices within the family network.

Family Space 3.0 includes UWB support, which allows for precise real-time navigation to locate devices with centimeter-level accuracy. This feature is particularly useful for quickly finding lost or misplaced devices within the home or other trusted locations. The system is designed to expand the ecosystem to include iOS phones, making the system compatible with a wider range of devices and allowing for seamless integration across different operating systems.

Of particular interest to embodiments of the present disclosure, Family Space 3.0 simplifies family monitoring by tracking device locations, setting daily time limits, and managing app access. These features help parents ensure their children's safety and manage their device usage effectively. Overall, Family Space 3.0 aims to provide a comprehensive and user-friendly solution for family safety and device management, leveraging advanced technologies and seamless integration to enhance the overall user experience.

Still, even with Family Space 3.0, the current process for switching between devices involves multiple steps, often requiring physical tools or assistance from service providers as noted above. The need to physically remove and swap SIM cards, visit service provider locations, or navigate through multiple steps on a service provider's website to request a change of activation from one SIM to another adds to the inconvenience.

In the context of Family Space 3.0, challenges arise when kids leave trusted places like home to spend time with family or play outside. Parents, experiencing stress and concern over the inability to promptly communicate or track their child, often resort to purchasing separate SIM cards for each child, incurring unexpected costs. Some parents may opt to manage a spare SIM, assigning it to the child when they leave home. However, this approach is cumbersome, requiring parents to remember and switch SIM.

The introduction of eSIMs offers some benefits, but it does not completely address the issue. An eSIM, or embedded SIM, acts as a digital counterpart to the traditional physical SIM card used in mobile phones. Unlike traditional SIM cards, which are removable and can be physically swapped between devices, an eSIM is integrated directly into the device's hardware. This integration provides greater flexibility and convenience in managing mobile network connections.

To activate a mobile phone with an eSIM, the user must download a digital profile from the mobile network operator. This profile includes all the necessary information to connect the device to the network, such as the user's phone number, network settings, and subscription details. Typically, the user scans a QR code provided by the carrier or manually enters a code to initiate the download of the eSIM profile.

Once the eSIM profile is downloaded and installed on the device, the mobile phone can connect to the carrier's network just like a traditional SIM card. The eSIM can store multiple profiles, enabling users to switch between different carriers or plans without physically changing SIM cards. This feature is especially useful for frequent travelers who need to switch between local carriers in different countries.

While an eSIM embeds the SIM functionality directly into a device's hardware, it does not solve the family problem due to the fact that when an eSIM is shared among family members, an administrative member must remember to transfer the eSIM from one member to the next each and every time the eSIM needs to be used by a different family member.

To illustrate how problematic this is, consider the following scenario: John and Mary, a couple with two children, Alex and Emma, face challenges in keeping track of their children's whereabouts when they leave home. Both children enjoy spending time with friends and playing outside, which often leaves the parents anxious about their safety.

Initially, John and Mary opted to buy separate SIM cards for each child to address this concern. However, this solution unexpectedly increased their monthly expenses. One day, while discussing this recurring issue, John suggested managing a spare SIM that could be assigned to the children when needed. Mary pointed out the inconvenience of manually switching the SIM every time the children left home. They wondered if there was a way to seamlessly transfer the SIM to the child's device when they were about to leave a trusted location, allowing them to effectively communicate with the children via their phones.

Advantageously, embodiments of the disclosure provide a solution to John and Mary's dilemma. To wit, embodiments of the disclosure simplify the SIM switching process by enabling the seamless transfer of eSIM configurations among linked family devices based on location and other contextual triggers. Advantageously, embodiments of the disclosure thereby reduce the complexity and cost associated with managing multiple SIM cards.

In one or more embodiments, a single eSIM is shared among linked family devices on demand. In one or more embodiments, one or more processors of an electronic device determine an eSIM is available on demand, and further detect when a device is about to move away from a trusted location, such as a home. In one or more embodiments, the one or more processors then initiate a seamless transfer of the eSIM configuration from one user to another. Advantageously, this approach alleviates the burden of manually switching eSIM and reduces the associated costs, providing a more efficient and streamlined method for managing mobile network connections within a family setting.

In one or more embodiments, the one or more processors manage the rotation of an eSIM account among a linked set of family devices. In one or more embodiments, the process begins with a first electronic device, acting as a dependent device within a set of family-linked devices, determining the availability of an eSIM card that is shared and associated with a trusted location, such as a home.

In one or more embodiments, the system then identifies that the eSIM card is currently configured to a default second dependent device located at the trusted location. Upon detecting that the first dependent device is about to move away from the trusted location, the system initiates a seamless transfer of the eSIM configuration from the second dependent device to the first dependent device.

Detection of the first device's movement can occur based on various triggers, including the device's schedule, calendar information, or historical events, such as regular activities like tuition or sports practice. Once the system detects an upcoming movement, the system authenticates the transfer request on the first dependent device. After successful verification, the system completes the eSIM transfer process.

Subsequently, the system monitors the first device's return to the trusted location and, upon detecting this event, initiates the transfer of the eSIM back to the default dependent device. In another embodiment, if multiple dependent family devices are about to leave the trusted location simultaneously, the system employs a priority policy to determine which device will be configured with the shared eSIM.

This priority can be based on factors such as the age of the child using the device, the destination location, or whether the devices will remain together or separate. This approach ensures efficient and contextually appropriate management of the eSIM among family devices, reducing the need for manual intervention and enhancing overall convenience.

In one or more embodiments, a method in an electronic communication device involves determining, by one or more processors of the electronic communication device, that a communication device of the electronic device is operable with an eSIM having at least a first profile associated with the electronic communication device and at least a second profile associated with at least a second electronic communication device while the eSIM is operating with the first profile in a trusted location. In one or more embodiments, the method further includes determining, by the one or more processors from signals received by the communication device from the second electronic communication device, that the second electronic communication device is departing the trusted location.

In one or more embodiments, in response to the second electronic communication device departing the trusted location, the method performs a transfer of the eSIM from the electronic communication device to the second electronic communication device. This transfer process ensures that the second electronic communication device can utilize the eSIM's network connectivity as the second electronic communication device moves away from the trusted location, thereby maintaining seamless communication and network access. The method leverages the capabilities of the processors to manage the eSIM profiles dynamically, ensuring efficient and contextually appropriate management of the eSIM among linked family devices.

Advantageously, the method enables seamless management of eSIM profiles among linked family devices based on location. By determining that a communication device is operable with an eSIM having multiple profiles and detecting when a second device is departing a trusted location, the method facilitates an automatic transfer of the eSIM from one device to another. This arrangement eliminates the need for manual intervention, physical tools, or assistance from service providers, thereby simplifying the process of switching eSIMs between devices.

The practical application of this method is particularly beneficial in family settings where multiple members share a single eSIM. For example, when a child leaves home, the system can automatically transfer the eSIM to the child's device, ensuring continuous connectivity and communication without the parents needing to manually switch the SIM. This enhances convenience, reduces costs associated with managing multiple SIM cards, and alleviates the stress of ensuring children have network access when away from home.

Additionally, the method leverages signals received from the second device to accurately determine its departure from the trusted location, ensuring timely and contextually appropriate eSIM transfers. This improves the overall user experience by providing a reliable and efficient solution for managing mobile network connections within a family.

In one or more embodiments, an electronic communication device comprises a communication device operable with an eSIM having at least a first profile associated with the electronic communication device and at least a second profile associated with at least a second electronic communication device. The electronic communication device further includes one or more processors operable with the communication device.

In one or more embodiments, the one or more processors, in response to detection of a trusted location departure event, initiate a transfer of the eSIM from the second electronic communication device to the electronic communication device. In one or more embodiments, the one or more processors only initiate the transfer of the eSIM when the trusted location departure event occurs while the eSIM is operating with the second profile at the second electronic communication device at the trusted location.

In one or more embodiments, the trusted location departure event is scheduled in a calendaring application operating on the one or more processors. The one or more processors can initiate the transfer of the eSIM in accordance with a prioritization schedule defining a prioritization of the electronic communication device and the second electronic communication device. The one or more processors can initiate another transfer of the eSIM to the second electronic communication device from the electronic communication device in response to detection of a trusted location entry event.

This arrangement allows for seamless and automatic management of eSIM profiles among linked family devices based on location. By detecting a trusted location departure event, the system can dynamically transfer the eSIM from one device to another without requiring manual intervention. This reduces the complexity and inconvenience associated with physically swapping SIM cards or navigating through multiple steps on a service provider's website.

The processors'ability to initiate the transfer of the eSIM ensures that the second electronic communication device can maintain network connectivity as it moves away from the trusted location, thereby providing continuous communication and network access. This is particularly beneficial in family settings where multiple members share a single eSIM, as it ensures that children or other family members have network access when they leave home, enhancing safety and convenience.

Additionally, the use of signals received from the second device to accurately determine its departure from the trusted location ensures timely and contextually appropriate eSIM transfers. This improves the overall user experience by providing a reliable and efficient solution for managing mobile network connections within a family, reducing costs associated with managing multiple SIM cards, and alleviating the stress of ensuring family members have network access when needed.

In one or more embodiments, a method in an electronic communication device involves detecting, by one or more processors of the electronic communication device, that a communication device of the electronic device is operable with an eSIM having at least a first profile associated with another electronic communication device and at least a second profile associated with the electronic communication device while the eSIM is operating with the first profile in a trusted location. In one or more embodiments, the method further includes determining, by the one or more processors, that the electronic communication device is departing the trusted location.

In one or more embodiments, upon determining that the electronic communication device is departing the trusted location, the method initiates a transfer of the eSIM from the another electronic communication device to the electronic communication device. This transfer process ensures that the electronic communication device can utilize the eSIM's network connectivity as the electronic communication device moves away from the trusted location, thereby maintaining seamless communication and network access.

Advantageously, the method leverages the capabilities of the processors to manage the eSIM profiles dynamically, ensuring efficient and contextually appropriate management of the eSIM among linked family devices. The determining step can comprise accessing a schedule of events stored in a calendaring application operable on the one or more processors. This allows the system to predict and respond to scheduled movements of the electronic communication device, ensuring timely and accurate eSIM transfers. This approach enhances the overall user experience by providing a reliable and efficient solution for managing mobile network connections within a family, reducing the need for manual intervention and ensuring continuous connectivity for family members. Other advantages will be described below. Still others will be obvious to those of ordinary skill in the art having the benefit of this disclosure.

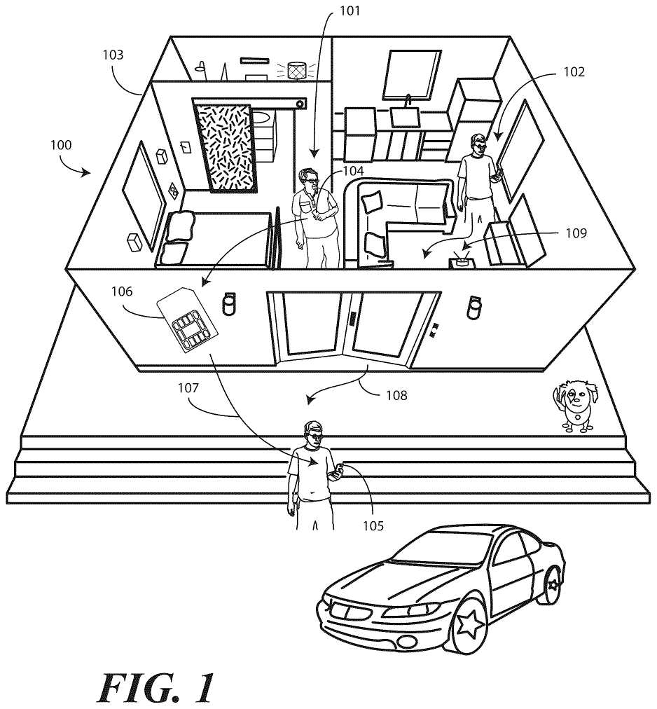

Turning now to FIG. 1, illustrated therein is one explanatory system suitable for using an electronic device configured in accordance with one or more embodiments of the disclosure to performing, in response to a second electronic communication device 105 departing a trusted location 100, a transfer 107 of the eSIM 106 credentials from a first electronic communication device 104 to the second electronic communication device 105. The trusted location 100 illustrated in FIG. 1 is a dwelling, which is a house in this explanatory embodiment. In other embodiments, the structure defining interior and exterior spaces of the trusted location could be a building, condominium, apartment complex, or other type of structure.

In one or more embodiments, the trusted location 100 is user definable and can be defined by, or within, a residence 103, e.g., a land parcel with predefined metes and bounds, belonging to the authorized user of the first electronic communication device 104 and another authorized user of the second electronic communication device 105. For example, in one or more embodiments the trusted location 100 can be defined as being only a predefined portion of the residence 103 belonging to the authorized user 101 of the first electronic communication device 104 and the other authorized user 102 of the second electronic communication device 105.

One or both of the authorized user 101 of the first electronic communication device 104 and the other authorized user 102 of the second electronic communication device 105 may use user settings of a menu to define, for instance, a dwelling (the house in this example) being the trusted location 100, or predefined portion of the residence 103 of the authorized user 101 of the first electronic communication device 104 and the other authorized user 102 of the second electronic communication device 105 as the trusted location 100. Alternatively, the authorized user 101 of the first electronic communication device 104 and other authorized user 102 of the second electronic communication device 105 may use the user settings to define only a portion of the dwelling situated at the residence 103 as the trusted location 100. Other examples will be described below. Still others will be obvious to those of ordinary skill in the art having the benefit of this disclosure.

In the illustrative embodiment of FIG. 1, the trusted location 100 includes walls defining both indoor and outdoor areas. The trusted location 100 includes various structural elements and spaces that are part of the system's operation in initiating a transfer 107 of the eSIM 106 from the first electronic communication device 104 to the second electronic communication device 105.

The interior of the trusted location 100 represents the enclosed spaces within the structure. The interior includes multiple rooms and areas where electronic devices may be located. The bathroom is one explanatory room within the interior. The bedroom is another room within the interior of the trusted location 100. The exterior of the trusted location 100 represents the outdoor areas surrounding the structure. The hallway is a passage within the interior that connects different rooms. The main room is a central area within the interior. The front porch is a transitional area between the interior and the exterior. The yard is an open space within the exterior.

As shown in FIG. 1, a first authorized user 101 of a first electronic communication device 104 and a second authorized user 102 of a second electronic communication device 105 are initially situated within the interior of the trusted location 100. In this example, the first authorized user 101 and the second authorized user 102 are enrolled in a family linked communication plan, with the first electronic communication device 104 and the second electronic communication device 105 being dependent devices among a set of dependent family linked devices. Illustrating by example, the first authorized user 101 and second authorized user 102 may be brothers, with the first electronic communication device 104 and the second electronic communication device 105 being dependent family devices linked to their father's account or mother's account. Thus, in one or more embodiments the first electronic communication device 104 and the second electronic communication device 105 are dependent devices from a third electronic communication device.

In this illustration, the first electronic communication device 104 and the second electronic communication device 105 share an eSIM 106, which is shown illustratively in FIG. 1 as a physical card, but which instead represents a digital data version of a traditional SIM card used in mobile phones. Unlike a physical SIM card that a user can remove and insert into different devices, an eSIM 106 is built into the device's hardware and can be programmed to connect to a mobile network. The concept of sharing one eSIM 106 between two electronic communication devices involves transferring the eSIM's network connectivity from one device to another without needing to physically swap a SIM card. This process allows both devices to use the same mobile network connection at different times, depending on which device needs the network connectivity.

Illustrating by example, in FIG. 1 both the first electronic communication device 104 and the second electronic communication device 105 are both linked to a family account. The eSIM 106 may initially be active on the first electronic communication device 104, thereby allowing authorized user 101 to use the first electronic communication device 104 to connect to the mobile network.

In accordance with embodiments of the disclosure, one or more processors of either the first electronic communication device 104 or the second electronic communication device 105, or alternatively a central device such as a router 109, can monitor the location and activities of both devices. For example, if authorized user 102 is about to leave the trusted location 100 with the second electronic communication device 105, In one or more embodiments the system detects this movement.

In one or more embodiments, when second electronic communication device 105 is detected as departing 108 the trusted location, the system initiates a transfer of the eSIM 106, namely, the eSIM's network connectivity, from the first electronic communication device 104 to the second electronic communication device 105. This means that authorized user 102 can now use the second electronic communication device 105 to connect to the mobile network.

In one or more embodiments, the system authenticates the transfer request to ensure the transfer request is legitimate. Once verified, the eSIM configuration is updated, and the second electronic communication device 105 becomes active on the mobile network using the eSIM 106.

In one or more embodiments, when the second electronic communication device 105 returns to the trusted location 100, the system can transfer the eSIM's network connectivity back to the first electronic communication device 104. This ensures that the first electronic communication device 104 can use the mobile network again.

In one or more embodiments, if multiple devices need to use the eSIM 106 simultaneously, the system can prioritize which device gets the eSIM 106 based on factors like the user's age, destination, or whether the devices will stay together or separate. By automating this process, the system eliminates the need for manual intervention, making the process easier and more convenient for family members to share a single eSIM 106 across multiple devices. This approach reduces costs and ensures continuous connectivity for the devices that need continuous connectivity most.

In one or more embodiments, one or more processors of first electronic communication device 104 determine that a communication device of the first electronic communication device 104 is operable with an eSIM 106 having at least a first profile associated with the first electronic communication device 104 and at least a second profile associated with at least a second electronic communication device 105. In one or more embodiments, this occurs while the eSIM 106 is operating with the first profile in a trusted location 100.

In one or more embodiments, the one or more processors determine, from signals received by the communication device from the second electronic communication device 105, that the second electronic communication device 105 is departing 108 the trusted location 100. In one or more embodiments, when this occurs, the one or more processors of the first electronic communication device 104 perform, in response to the second electronic communication device 105 departing 108 the trusted location, a transfer of the eSIM 106 from the electronic communication device 104 to the second electronic communication device 105. In one or more embodiments, this performing comprises causing a transition of the eSIM 106 from the first profile to the second profile, thereby allowing the second authorized user 102 to use the second electronic communication device 105 to connect to a mobile network.

In one or more embodiments, performing the transfer of the eSIM 106 to the second electronic communication device 105 further comprises the communication device of the first electronic communication device 104 receiving authentication of a transfer request for the eSIM from the second electronic communication device 105. In one or more embodiments, this process further comprises deactivating, by the one or more processors of the first electronic communication device 104, the eSIM 106 at the first electronic communication device 104 once the eSIM 106 becomes operational on the second electronic communication device 105.

The process can happen in reverse when the second electronic communication device 105 returns to the trusted location 100. Said differently, in one or more embodiments the one or more processors of the first electronic communication device 104 also determine, from other signals received by the communication device, that the second electronic communication device 105 is returning to the trusted location 100. In one or more embodiments, the one or more processors initiate, in response to the second electronic communication device 105 returning to the trusted location 100, another transfer of the eSIM 106 from the second electronic communication device 105 to the first electronic communication device 104.

In one or more embodiments, when this occurs, the one or more processors of the first electronic communication device 104 authenticate a transfer request upon verifying that a transition of the eSIM 106 from the second profile to the first profile has occurred. The one or more processors of the first electronic communication device 104 can then activate the eSIM 106 as the first electronic communication device 104.

The system described in FIG. 1 can determine that an electronic communication device is leaving the trusted location 100 using several techniques. These techniques include using location information, historic events, calendar information, or sensor data. Others will be obvious to those of ordinary skill in the art having the benefit of this disclosure.

In one or more embodiments, the system can use GPS or other location-based services to track the device's position. When the device's location changes beyond a predefined boundary of the trusted location 100, the system detects that the device is leaving. This method provides real-time and precise tracking of the device's movements, ensuring accurate detection of departure from the trusted location 100.

In other embodiments, the system can analyze historical data to predict when a device is likely to leave the trusted location 100. For example, if a child regularly leaves home for school at eight in the morning, the system can anticipate this event based on past behavior. This method allows the system to proactively manage eSIM 106 transfers based on predictable patterns, reducing the need for real-time tracking.

In still other embodiments, the system can access calendar events stored on the device. If an event indicates that the user has an appointment or activity outside the trusted location 100, the system can prepare for the device's departure. This method leverages existing user data to make informed decisions about eSIM transfers, ensuring that the system aligns with the user's schedule. Thus, in one or more embodiments the signals received by the communication device of the first electronic communication device 104 from the second electronic communication device 105 indicate that an event is occurring at a scheduled time that will cause the second electronic communication device 105 to leave the trusted location 100.

In still other embodiments, the system can use data from various sensors on the device, such as accelerometers, to detect movement. If the device shows signs of significant movement, the system can infer that the device is leaving the trusted location 100. This method provides an additional layer of detection, especially useful in scenarios where location services may be unreliable or unavailable. By employing these techniques, the system ensures that eSIM transfers are managed efficiently and contextually, maintaining seamless communication and network access for family members as they move in and out of trusted locations.

When both electronic communication devices leave the trusted location 100, various prioritization schemes can be used to determine which electronic communication device gets the eSIM 106. Illustrating by example, in one or more embodiments the one or more processors of the first electronic communication device 104 might also determine, from one or more sensors, that the first electronic communication device 104 is departing the trusted location 100 within a predefined time window during which the second electronic communication device 105 is also departing the trusted location 100. In one or more embodiments, when this occurs, the one or more processors obtain from a memory of the first electronic communication device, a prioritization schedule prioritizing the first electronic communication device 104 and the second electronic communication device 105.

In one or more embodiments, the one or more processors preclude the performing of the transfer of the eSIM 106 from the first electronic communication device 104 to the second electronic communication device 105 when the first electronic communication device 104 is prioritized above the second electronic communication device 105, or vice versa. In one or more embodiments, the prioritization schedule is defined by ages of authorized users of the first electronic communication device 104 and the second electronic communication device 105, respectively. Thus, the older of the two brothers may get the eSIM 106 when both brothers leave the residence 103, or vice versa.

In other embodiments, the prioritization schedule is a function of destination locations for the first electronic communication device 104 and the second electronic communication device 105. If the first brother is going to work while the second brother is going to visit a girlfriend, the work obligation may take precedence, thereby allowing the first brother to use the eSIM 106. Alternatively, the parents may want to reward the first brother for working and may not particularly like the second brother's girlfriend, and therefore may reward the first brother for his productivity. In still other embodiments, the arrangement of the prioritization schedule depends upon whether destination locations for the electronic communication device and the second electronic communication device are the same or are different. Other prioritization resolution techniques will be obvious to those of ordinary skill in the art having the benefit of this disclosure.

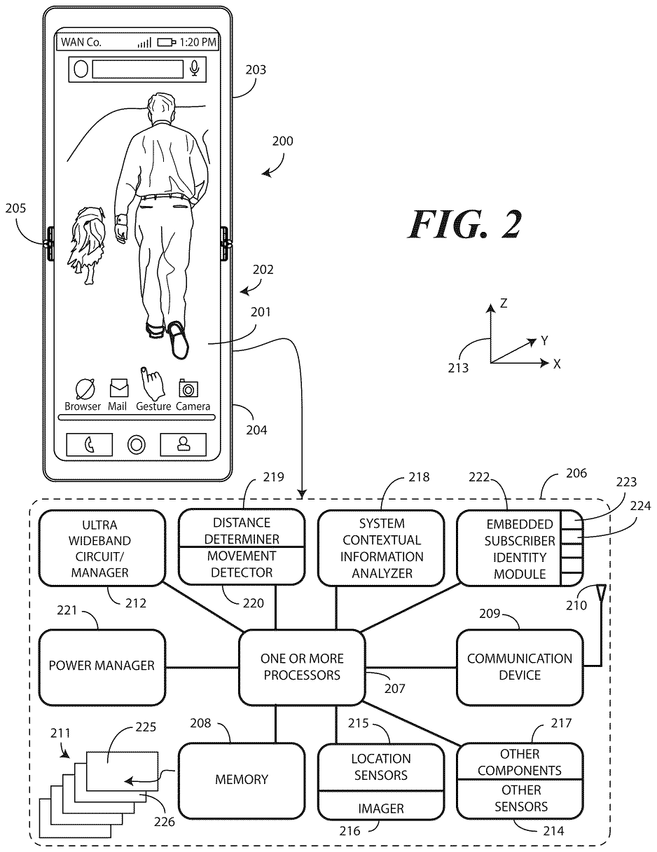

Turning now to FIG. 2, illustrated therein is one explanatory electronic device 200 configured in accordance with one or more embodiments of the disclosure. The electronic device 200 of FIG. 2 is a portable electronic device and is shown as a smartphone for illustrative purposes. However, it should be obvious to those of ordinary skill in the art having the benefit of this disclosure that other electronic devices may be substituted for the explanatory smart phone of FIG. 2. For example, the electronic device 200 could equally be a conventional desktop computer, palm-top computer, a tablet computer, a gaming device, a media player, or other device.

This illustrative electronic device 200 includes a display 201, which may optionally be touch sensitive. Users can deliver user input to the display 201, which serves as a user interface for the electronic device 200. In one embodiment, users can deliver user input to the display 201 of such an embodiment by delivering touch input from a finger, stylus, or other objects disposed proximately with the display 201. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 also includes a device housing 202. In one embodiment, the device housing 202 includes two housing members, namely, a first device housing 203 that is coupled to a second device housing 204 by a hinge 205 such that the first device housing 203 is pivotable about the hinge 205 relative to the second device housing 204 between a closed position and an axially displaced open position. In other embodiments, such as that associated with the first electronic communication device (104) and second electronic communication device (105) of FIG. 1, the device housing 202 will be rigid and will include no hinge.

In still other embodiments, the device housing 202 will be manufactured from a flexible material such that it can be bent and deformed. Where the device housing 202 is manufactured from a flexible material or where the device housing 202 includes a hinge, the display 201 can be manufactured on a flexible substrate such that it bends. In one or more embodiments, the display 201 is configured as a flexible display that is coupled to the first device housing 203 and the second device housing 204, spanning the hinge 205. Features can be incorporated into the device housing 202, including control devices, connectors, and so forth.

Also shown in FIG. 2 is an explanatory block diagram schematic 206 of the explanatory electronic device 200. In one or more embodiments, the block diagram schematic 206 is configured as a printed circuit board assembly disposed within the device housing 202 of the electronic device 200. Various components can be electrically coupled together by conductors or a bus disposed along one or more printed circuit boards.

The illustrative block diagram schematic 206 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

In one embodiment, the electronic device includes one or more processors 207. In one embodiment, the one or more processors 207 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 206. Each of the application processor and the auxiliary processor(s) can be configured to process and execute executable software code to perform the various functions of the electronic device with which the block diagram schematic 206 operates. A storage device, such as memory 208, can optionally store the executable software code used by the one or more processors 207 during operation.

In this illustrative embodiment, the block diagram schematic 206 also includes a communication device 209 that can be configured for wired or wireless communication with one or more other devices or networks. The networks can include a wide area network, a local area network, and/or personal area network. The communication device 209 may also utilize wireless technology for communication, such as, but are not limited to, peer-to-peer or ad hoc communications such as HomeRF, Bluetooth.sup.TM and IEEE 802.11, and other forms of wireless communication such as infrared technology. The communication device 209 can include wireless communication circuitry, one of a receiver, a transmitter, or transceiver, and one or more antennas 210.

In one embodiment, the one or more processors 207 can be responsible for performing the primary functions of the electronic device with which the block diagram schematic 206 is operational. For example, in one embodiment the one or more processors 207 comprise one or more circuits operable with the display 201 to present presentation information to a user. The executable software code used by the one or more processors 207 can be configured as one or more modules 211 that are operable with the one or more processors 207. Such modules 211 can store instructions, control algorithms, and so forth.

Illustrating by example, in one or more embodiments the communication device 209 is operable with an eSIM 222 having at least a first profile 223 associated with the electronic device 200 and at least a second profile 224 associated with at least a second electronic communication device. In one or more embodiments, the one or more processors 207 are operable with the communication device 209.

In one or more embodiments, the one or more processors 207, in response to detection of a trusted location departure event, initiate a transfer of the eSIM 222 from the electronic device 200 to the other electronic communication device. In one or more embodiments, the trusted location departure event is scheduled in a calendaring application 226 operating on the one or more processors 207.

In one or more embodiments, the one or more processors 207 only initiate the transfer of the eSIM 222 when the trusted location departure event occurs while the eSIM 222 is operating with the first profile 223 at the electronic device 200 at the trusted location. In one or more embodiments, the one or more processors 207 initiate the transfer of the eSIM 22 in accordance with a prioritization schedule 225 defining a prioritization of the electronic device 200 and the other electronic communication device. In one or more embodiments, the one or more processors 207 initiate another transfer of the eSIM 222 back to the electronic device 200 from the other electronic communication device in response to detection of a trusted location entry event.

In one or more embodiments, the block diagram schematic 206 includes an ultra-wideband component 212. In one or more embodiments, the ultra-wideband component is similar to the communication device 209 in that it is configured to perform wireless communications with one or more other ultra-wideband components that may be integrated into, or attached to, other devices.

The illustrative ultra-wideband component of FIG. 2 is a dedicated ultra-wideband transceiver constructed into the electronic device 200 configured to use the one or more antennas 210 or its own antenna structure to communicate, using ultra-wideband technology, with another ultra-wideband component. In one or more embodiments, the ultra-wideband component comprises wireless communication circuitry, one of a receiver, a transmitter, or transceiver, and one or more antennas, which may be separate from, or the same as, the one or more antennas 210 used by the communication device 209.

The inclusion of an ultra-wideband component 212 advantageously allows wireless communication with another ultra-wideband component connected to or integrated into another electronic device that is fast and secure, all while requiring very little power. In one or more embodiments, the ultra-wideband component 212 consumes at least an order of magnitude less energy than does the communication device 209.

In one or more embodiments, the ultra-wideband component 212 can also be used to measure angle of arrival. Effectively, when the one or more antennas 210 are configured as an antenna array, the ultra-wideband component 212 can compare signals received from one side of the antenna array with other signals received from another side of the antenna array to determine an orientation of the electronic device 200 in three-dimensional space 213 relative to other electronic devices having another ultra-wideband component attached thereto or integrated therein.

Thus, angle of arrival measures the phase difference between two receive antennas of an antenna array to determine the amount of relative angle offset between the antenna array and a source of the signals. If two devices are situated normal to each other, then the angle of arrival would be either zero or very small. Additionally, this angle of arrival is independent of distance. The angle of arrival measurement is capable of measuring where the electronic device 200 is in relation to another electronic device from which phase differentiated signals are received in terms of elevation and azimuth as well.

Time-difference-of-arrival techniques can also be used for locating companion electronic devices. Time-difference-of-arrival localization relies on measuring the difference in arrival times of a signal at multiple synchronized reference points, known as anchors. The process involves broadcasting a signal known as a “blink” message, which is received by an anchor, which in the context of the present disclosure would be an ultra-wideband wall plate or switch plate. These anchors record the exact time it receives the blink message. The recorded timestamps are then sent to a central location engine, which can be in the electronic device 200. The location engine uses a multi-lateration algorithm to calculate the position of the tag based on the differences in arrival times of the blink message at the various anchors.

Various sensors 214 can be operable with the one or more processors 207. One example of a sensor that can be included with the various sensors 214 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 207, to detect an object in close proximity with—or touching—the surface of the display 201 or the device housing 202 of the electronic device 200 by establishing electric field lines between pairs of capacitive sensors and then detecting perturbations of those field lines.

Another example of a sensor that can be included with the various sensors 214 is a geo-locator that serves as a location detector 215. In one embodiment, location detector 215 is able to determine location data. Location can be determined by capturing the location data from a constellation of one or more earth orbiting satellites, or from a network of terrestrial base stations to determine an approximate location. The location detector 215 may also be able to determine location by locating or triangulating terrestrial base stations of a traditional cellular network, or from other local area networks, such as Wi-Fi networks.

Another example of a sensor that can be included with the various sensors 214 is an orientation detector operable to determine an orientation and/or movement of the electronic device 200 in three-dimensional space 213. Illustrating by example, the orientation detector can include an accelerometer, gyroscopes, or other device to detect device orientation and/or motion of the electronic device 200. Using an accelerometer as an example, an accelerometer can be included to detect motion of the electronic device. Additionally, the accelerometer can be used to sense some of the gestures of the user, such as one talking with their hands, running, or walking.

The orientation detector can determine the spatial orientation of an electronic device 200 in three-dimensional space 213 by, for example, detecting a gravitational direction. In addition to, or instead of, an accelerometer, an electronic compass can be included to detect the spatial orientation of the electronic device 200 relative to the earth's magnetic field. Similarly, one or more gyroscopes can be included to detect rotational orientation of the electronic device 200.

In one or more embodiments, the various sensors 214 also comprise an image capture device 216. In one or more embodiments, the image capture device employs optical detection using image analysis to determine the locations of each companion electronic device. Similarly, the communication device 209 of the electronic device 200 can use received signal strength measurements to determine locations of the various companion electronic devices.

Other components 217 operable with the one or more processors 207 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 217 can also include proximity sensors. The proximity sensors fall into one of two camps: active proximity sensors and “passive” proximity sensors. Either the proximity detector components or the proximity sensor components can be generally used for gesture control and other user interface protocols.

The other components 217 can optionally include a barometer operable to sense changes in air pressure due to elevation changes or differing pressures of the electronic device 200. The other components 217 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 200. Similarly, a temperature sensor can be configured to monitor temperature about an electronic device.

A context engine 218 can then be operable with the various sensors to detect, infer, capture, and otherwise determine persons and actions that are occurring in an environment about the electronic device 200. For example, where included one embodiment of the context engine 218 determines assessed contexts and frameworks using adjustable algorithms of context assessment employing information, data, and events. These assessments may be learned through repetitive data analysis. Alternatively, a user may employ a menu or user controls via the display 201 to enter various parameters, constructs, rules, and/or paradigms that instruct or otherwise guide the context engine 218 in detecting multi-modal social cues, emotional states, moods, and other contextual information. The context engine 218 can comprise an artificial neural network or other similar technology in one or more embodiments.

In one or more embodiments, the context engine 218 is operable with the one or more processors 207. In some embodiments, the one or more processors 207 can control the context engine 218. In other embodiments, the context engine 218 can operate independently, delivering information gleaned from detecting multi-modal social cues, emotional states, moods, and other contextual information to the one or more processors 207. The context engine 218 can receive data from the various sensors 214. In one or more embodiments, the one or more processors 207 are configured to perform the operations of the context engine 218.

In one or more embodiments, the electronic device 200 includes a distance determination manager 219 that is operable with the ultra-wideband component 212 to determine a precise distance (within one centimeter) of the electronic device 200 in relation to other electronic devices also having ultra-wideband components or ultra-wideband tags (the difference between a ultra-wideband component and a ultra-wideband tag is that the ultra-wideband component is integrated into an electronic device as an original component, while a ultra-wideband tag is a self-contained ultra-wideband component that can be attached to an electronic device as a retrofit item to configure a legacy electronic device to communicate via ultra-wideband technology).

A motion detector 220 determines when the electronic device 200 moves. While ultra-wideband communication is very conservative with respect to power consumption, embodiments of the disclosure contemplate that the electronic device 200 can be even more efficient in creating the visual depiction of the environment with its corresponding locations of other companion electronic devices when the user moves the electronic device 200 toward those other companion electronic devices while the ultra-wideband circuit manager 212 is actively making distance measurements to the various wall plates and switch plates. Accordingly, the motion detector 220 can be used to detect such motion. In one or more embodiments, a power manager 221 can be configured to ensure that distance measurements, ultra-wideband communications, and other operations are only performed once the electronic device 200 has moved since the last similar operation was performed.

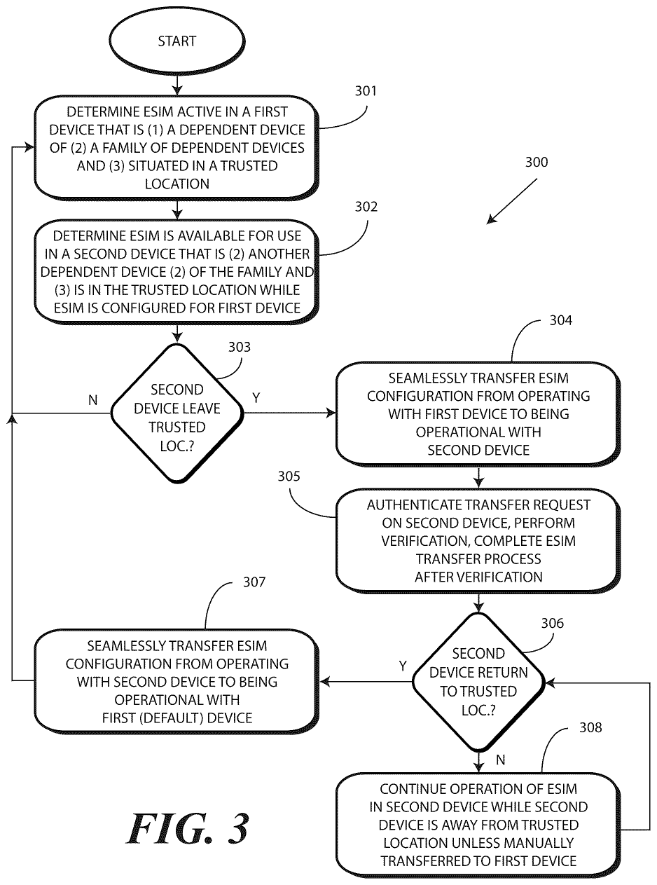

The electronic device 200 of FIG. 2 can use the one or more processors 207 to execute one or more operational method configured as one or more modules 211 stored in the memory 208 of the electronic device 200. Illustrating by example, turning now to FIG. 3, illustrated therein is one such method 300.

FIG. 3 shows a method 300 for managing the rotation of an eSIM account among a linked set of family devices. The method 300 begins at step 301. In one or more embodiments, step 301 comprises determining that an eSIM is active in a first device that is a dependent device of a family of dependent devices and situated in a trusted location.

At step 302, the method 300 then determines that the eSIM is available for use in a second device. In one or more embodiments, the second device is another dependent device of the family. In one or more embodiments, the second device is also in the trusted location while the eSIM is configured for the first device.

At decision 303, the method 300 checks if the second device is about to leave the trusted location. If decision 303 determines the second device is not leaving the trusted location, the method 300 returns to monitoring the status of the devices at step 301 and step 302.

Decision 303 can be performed in various different ways. Turning briefly to FIG. 6, illustrated therein are several ways that the method (300) of FIG. 3 can determine if an electronic communication device is leaving a trusted location. These techniques are illustrative only, as others will be obvious to those of ordinary skill in the art having the benefit of this disclosure.

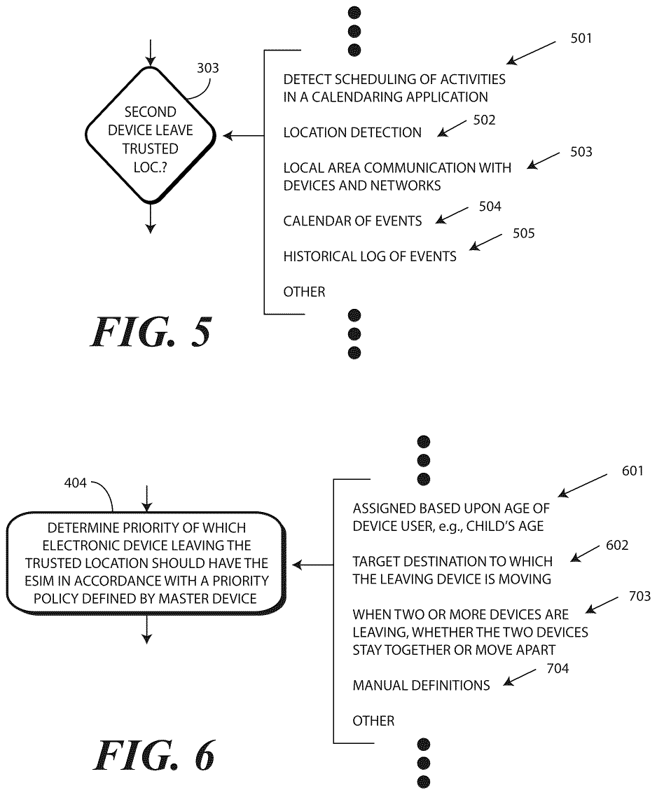

As shown in FIG. 5, decision 303 of the method (300) of FIG. 3 can determine if an electronic communication device is leaving a trusted location by detecting the scheduling of activities in a calendaring application 501. In one or more embodiments, the calendaring application 501 stores various events and activities that the user has scheduled, such as appointments, meetings, or regular activities. By accessing this information, decision 303 can predict when the device is likely to leave the trusted location based on the scheduled events.

For example, if the calendaring application 501 indicates that a child has a soccer practice scheduled every Tuesday at 4 PM, decision 303 can anticipate that the child's device will leave the trusted location around that time. Similarly, if the calendaring application 501 shows a doctor's appointment for a family member at 10 AM on a specific day, decision 303 can prepare for the device's departure from the trusted location at that time.

This proactive approach allows the system to manage the eSIM transfer efficiently, ensuring that the device has network connectivity when needed. Another use case involves a parent who has a recurring business meeting every Monday at 9 AM. The calendaring application 501 can notify the system of this regular event, prompting decision 303 to initiate the eSIM transfer process before the parent leaves the trusted location. This ensures that the parent's device remains connected to the network during the meeting, facilitating seamless communication and access to necessary resources.

In a scenario where multiple family members have overlapping schedules, the system can prioritize the eSIM transfer based on the calendaring application 501. For instance, if two children have activities scheduled at the same time, the system can determine which child's activity is more significant based on the event details and prioritize the eSIM transfer accordingly. This ensures that the device with the higher priority event maintains network connectivity, enhancing the overall user experience and convenience. By leveraging the scheduling information in the calendaring application 501, the system can accurately predict and manage the departure of electronic communication devices from the trusted location. This approach reduces the need for manual intervention, providing a seamless and efficient method for managing eSIM profiles among linked family devices.

In other embodiments, decision 303 can determine if an electronic communication device is leaving a trusted location using location detection 502. In one or more embodiments, this process involves leveraging various location-based technologies to monitor the device's position relative to predefined boundaries of the trusted location.

The system can utilize GPS or other location-based services to track the device's movements in real-time. When the device's location changes beyond a predefined boundary, the system detects that the device is leaving the trusted location. For instance, consider a scenario where a child regularly leaves home for school. The system can define the boundaries of the trusted location as the perimeter of the home. When the child's device crosses this boundary, the system detects the departure and initiates the eSIM transfer process. This ensures that the child's device maintains network connectivity while away from home, allowing parents to communicate and track their child's location. Another use case involves a family member who frequently travels for work.

In one or more embodiments, the system can define the trusted location as the home and the office. When the device leaves the home boundary and moves towards the office, the system detects this movement and prepares for the eSIM transfer. This ensures that the family member's device remains connected to the network during the commute, facilitating seamless communication and access to necessary resources. In a different scenario, the system can use location detection to manage eSIM transfers for multiple family members. For example, if two children are leaving home for different activities, the system can prioritize the eSIM transfer based on their destinations. The system can determine which child's activity is more significant and ensure that the device with the higher priority event maintains network connectivity. This approach enhances the overall user experience by providing a reliable and efficient solution for managing eSIM profiles among linked family devices.

In still other embodiments, decision 303 can determine if an electronic communication device is leaving a trusted location using electronic communication with other companion electronic devices 503. In one or more embodiments, this process involves leveraging the communication capabilities of the electronic device to interact with other devices within the trusted location.

By establishing a network of companion devices, the system can monitor the presence and movement of the electronic communication device relative to these companion devices. For instance, consider a scenario where a family home is equipped with multiple companion devices, such as smart speakers, security cameras, and other connected devices. When the electronic communication device, such as a child's smartphone, moves within the home, the smartphone continuously communicates with these companion devices.

The system can track the signal strength and connectivity status between the smartphone and the companion devices. If the signal strength weakens or the connection is lost with a significant number of companion devices, the system can infer that the smartphone is moving away from the trusted location. In another use case, a smart home environment may include wearable devices, such as smartwatches, that family members use.

These wearables can communicate with the electronic communication device to provide additional context about the user's location. For example, if a child wearing a smartwatch leaves the home, the smartwatch can detect the departure and send a signal to the electronic communication device. The system can then use this information to determine that the child, along with the electronic communication device, is leaving the trusted location.

Additionally, the system can utilize ultra-wideband (UWB) technology to enhance the accuracy of location detection. UWB-enabled companion devices can provide precise distance measurements between the electronic communication device and the companion devices. For example, if a family member's smartphone equipped with UWB technology moves towards the front door, the UWB-enabled smart lock can detect the proximity and communicate this information to the system. The system can then determine that the smartphone is about to leave the trusted location based on the decreasing distance to the smart lock. By employing these techniques, the system ensures efficient and contextually appropriate management of eSIM transfers, maintaining seamless communication and network access for family members as they move in and out of trusted locations.

In still other embodiments, decision 303 can determine if an electronic communication device is leaving a trusted location using a networked calendar of events 504. In one or more embodiments, this process involves leveraging a shared calendaring system that synchronizes events across multiple devices within a family network.

In one or more embodiments, the system accesses the calendar data to predict and manage the departure of devices from the trusted location based on scheduled events. For instance, consider a scenario where a family uses a shared calendar to manage their daily activities. The calendar includes events such as school schedules, extracurricular activities, and appointments.

When a child's device is scheduled to leave for soccer practice at 4 PM, the system detects this event from the networked calendar. As the scheduled time approaches, the system prepares to transfer the eSIM configuration from the default device to the child's device, ensuring continuous network connectivity during the practice. In another use case, a parent has a recurring business meeting every Monday at 9 AM. The networked calendar reflects this regular event. The system detects the upcoming meeting and initiates the eSIM transfer process before the parent leaves the trusted location.

This proactive approach ensures that the parent's device remains connected to the network during the meeting, facilitating seamless communication and access to necessary resources. Additionally, the system can handle overlapping schedules for multiple family members. For example, if two children have activities scheduled at the same time, the system can prioritize the eSIM transfer based on the significance of each event. If one child has a doctor's appointment while the other has a playdate, the system may prioritize the doctor's appointment, ensuring that the device with the higher priority event maintains network connectivity. This approach enhances the overall user experience by providing a reliable and efficient solution for managing eSIM profiles among linked family devices

In still other embodiments, decision 303 of the method can determine if an electronic communication device is leaving a trusted location using a historical log of events 505. This process involves analyzing past behaviors and patterns to predict future movements of the device.

In one or more embodiments, the historical log of events 505 stores data related to the device's previous activities, such as times and locations of departures and arrivals, regular schedules, and recurring events. By leveraging this historical data, the system can identify trends and anticipate when the device is likely to leave the trusted location.

For instance, consider a scenario where a child leaves home for school every weekday at 8 AM. The historical log of events 505 records this pattern over several weeks. When the system detects that the time is approaching 8 AM on a weekday, the system can predict that the child's device is about to leave the trusted location. This prediction allows the system to initiate the eSIM transfer process in advance, ensuring that the child's device maintains network connectivity during the school day.

Another use case involves a family member who regularly attends a fitness class every Monday, Wednesday, and Friday at 6 PM. The historical log of events 505 captures this routine, noting the consistent departure times. As 6 PM approaches on these days, the system can anticipate the family member's departure based on the historical data. This proactive approach ensures that the device remains connected to the network during the fitness class, facilitating seamless communication and access to necessary resources. In a different scenario, a parent may have a recurring business trip that occurs on the first Monday of every month. The historical log of events 505 records the details of these trips, including departure times and durations. When the first Monday of the month arrives, the system can predict the parent's departure based on the historical pattern. This allows the system to prepare for the eSIM transfer, ensuring that the parent's device remains connected to the network during the trip. By utilizing the historical log of events 505, the system can efficiently manage eSIM transfers based on predictable patterns and behaviors. This approach reduces the need for real-time tracking and manual intervention, providing a reliable and efficient solution for managing eSIM profiles among linked family devices.

Turning now back to FIG. 3, if decision 303 determines the second device is leaving the trusted location, step 304 initiates a seamless transfer of the eSIM configuration from operating with the first device to being operational with the second device. At step 305, the method 300 then authenticates the transfer request on the second device, performs verification, and completes the eSIM transfer process after verification.

Decision 306 then continues to monitor the status of the second device to determine if the second device returns to the trusted location. If decision 306 determines the second device returns to the trusted location, the method 300 seamlessly transfers the eSIM configuration from operating with the second device to being operational with the first (default) device at step 307. By contrast, if decision 306 determines the second device does not return to the trusted location, the eSIM continues to operate in the second device while the second device is away from the trusted location at step 308 unless manually transferred to the first device. This method 300 ensures that the eSIM configuration is dynamically managed based on the location and movement of the dependent devices within the family, providing seamless connectivity and reducing the need for manual intervention.

Thus, as shown the method 300 of FIG. 3 detects, optionally using one or more processors of an electronic communication device, detects that a communication device of the electronic device is operable with an eSIM having at least a first profile associated with another electronic communication device and at least a second profile associated with the electronic communication device while the eSIM is operating with the first profile in a trusted location at step 301. In one or more embodiments, the method 300 determines, by the one or more processors at decision 303, that the electronic communication device is departing the trusted location. In one or more embodiments, when this occurs step 304 initiates, in response to the electronic communication device departing the trusted location, a transfer of the eSIM from the another electronic communication device to the electronic communication device.

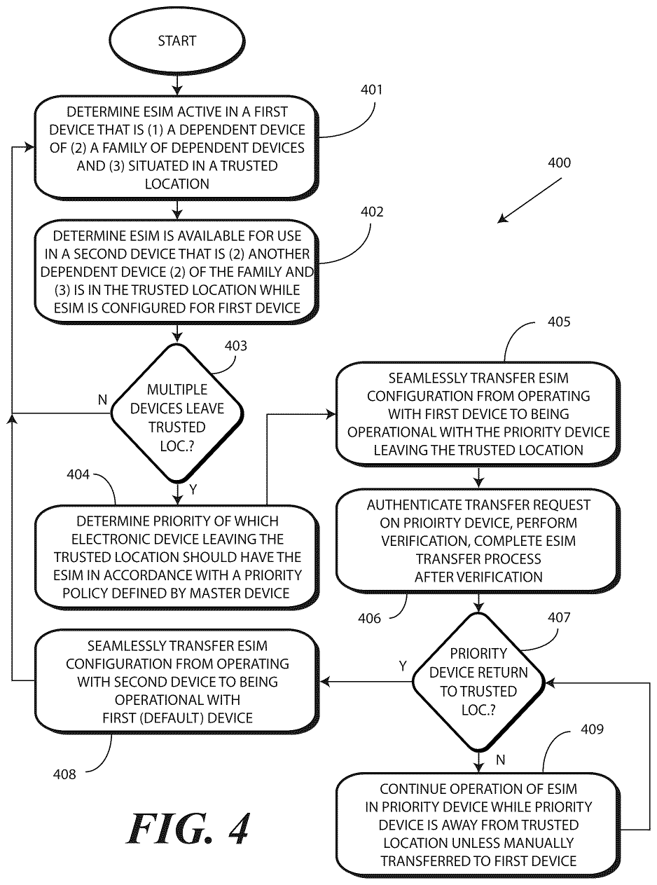

Embodiments of the disclosure contemplate that issues can arise when multiple devices using the same eSIM each leave a trusted location. Turning now to FIG. 4, illustrated therein is a method 400 to deal with such situations.

The method 400 begins at step 401. In one or more embodiments, step 401 determines that an eSIM is active in a first device. In one or more embodiments, this first device is a dependent device within a family of dependent devices and is situated in a trusted location.

In one or more embodiments, the trusted location can be defined by the user and may include a residence or a specific area within a residence. The first device, which could be a smartphone, tablet, or other electronic communication device, operates with an eSIM that has multiple profiles. The system identifies that the eSIM is currently active on the first device, allowing the first device to connect to the mobile network.

At step 402, the method 400 determines that the eSIM is available for use in a second device. In one or more embodiments, the second device is another dependent device within the same family and is also located in the trusted location.

In one or more embodiments, the system checks the status of the eSIM and confirms that the eSIM can be transferred from the first device to the second device at step 402. This step 402 ensures that the eSIM is not locked or restricted to a single device and can be dynamically managed among multiple devices within the family.

At decision 403, the method 400 detects whether multiple devices are leaving trusted location. In one or more embodiments, decision 403 determines whether multiple devices are about to leave the trusted location simultaneously. In one or more embodiments, this decision 403 is important for managing the eSIM transfer process efficiently. If only one device is leaving, the system can proceed with the transfer as described above with reference to the method (300) of FIG. 3. If multiple devices are leaving, as determined by decision 403, the method 400 needs to determine which device to prioritize to receive the eSIM at step 404.

At step 404, when multiple devices are leaving the trusted location, the method 400 employs a priority policy to decide which device will be configured with the shared eSIM. The priority policy can be based on various factors, such as the age of the user, the destination location, or whether the devices will stay together or separate. For example, a device used by a younger child or a device heading to a more significant destination may be given higher priority. The system evaluates these factors and determines the most appropriate device to receive the eSIM configuration.

Turning briefly to FIG. 6, illustrated therein are some ways that step 404 can be performed. Others will be obvious to those of ordinary skill in the art having the benefit of this disclosure.

In one or more embodiments, determining the priority of which electronic device leaving the trusted location receives the eSIM at step 404 can, in one embodiment, be determined as a function of the age 601 of the authorized user. This approach ensures, in one explanatory embodiment, that the device used by the most vulnerable or dependent family member receives network connectivity first, enhancing safety and communication.

For instance, in a family with multiple children, the system can prioritize the eSIM transfer to the device used by the youngest child. This ensures that the youngest child, who may require more supervision and immediate access to communication, remains connected to the network when leaving the trusted location.

In another use case, consider a scenario where a family has both a teenager and a younger child. The teenager may have more independence and less need for constant communication with parents.

By prioritizing the eSIM transfer to the younger child's device, step 404 can ensure that the younger child can easily contact parents or guardians if needed. This approach provides peace of mind to parents, knowing that their younger child has reliable network access when away from home.

Additionally, in a situation where both parents and children are leaving the trusted location simultaneously, step 404 can prioritize the eSIM transfer based on the age 601 of the children. For example, if a parent and a young child are both leaving for different activities, step 404 can prioritize the eSIM transfer to the child's device. This ensures that the child has network connectivity for safety and communication, while the parent, who may have other means of communication, can manage without the eSIM temporarily.

By leveraging the age of the authorized user as a determining factor for eSIM transfer priority, the system can dynamically manage network connectivity in a way that enhances safety and communication for the most dependent family members. This approach reduces the need for manual intervention and ensures that the devices requiring the most immediate access to network services receive priority, thereby improving the overall user experience within a family setting.

In other embodiments, as shown in FIG. 6, determining the priority of which electronic device leaving the trusted location receive the eSIM at step 404 can, in one embodiment, be determined as a function of the target destination 602 to which the electronic devices are moving. This approach ensures that the device heading to a more significant destination receives network connectivity first, enhancing communication and safety.

For instance, consider a scenario where two children in a family are leaving home simultaneously. One child is heading to school, while the other is going to a friend's house for a playdate. Step 404 can prioritize the eSIM transfer to the device of the child going to school, as this destination is more significant for maintaining communication with parents and ensuring the child's safety. The school environment may require the child to have reliable network access for emergencies or to receive important updates from parents.

In another use case, a family member may be traveling to a medical appointment while another family member is going to a recreational activity. Step 404 can prioritize the eSIM transfer to the device of the family member attending the medical appointment. This ensures that the family member has continuous network connectivity to communicate with healthcare providers, receive appointment reminders, or contact family members if needed. The medical appointment is a more significant destination compared to the recreational activity, warranting higher priority for network access.

Additionally, consider a scenario where a parent and a teenager are both leaving home for different activities. The parent is heading to a business meeting, while the teenager is going to a social event. Step 404 can prioritize the eSIM transfer to the parent's device, as the business meeting may require reliable network connectivity for accessing work-related information, participating in virtual meetings, or communicating with colleagues. The business meeting is a more significant destination compared to the social event, justifying the higher priority for the parent's device. By leveraging the target destination 602 as a determining factor for eSIM transfer priority, step 404 can dynamically manage network connectivity in a way that enhances safety, communication, and convenience for family members. This approach reduces the need for manual intervention and ensures that the devices heading to more significant destinations receive priority, thereby improving the overall user experience within a family setting.

In still other embodiments, the determining the priority of which electronic device leaving the trusted location receives the eSIM at step 404 can, in one embodiment, be determined as a function of whether the electronic devices are staying together or moving apart 703. This approach ensures that the device requiring more immediate and reliable network connectivity receives priority, enhancing communication and safety for family members.

Consider a scenario where two children are leaving home for different activities. One child is going to a friend's house, while the other is heading to a sports practice. If the children are moving apart, step 404 can prioritize the eSIM transfer to the device of the child going to the sports practice. This ensures that the child at the sports practice, who may need to communicate with parents or coaches, has reliable network access. The child going to the friend's house, who may have access to other communication means, can manage without the eSIM temporarily.

In another use case, a parent and a teenager are both leaving home for different destinations. The parent is going to a business meeting, while the teenager is going to a social event. If the parent and teenager are moving apart 703, the system can prioritize the eSIM transfer to the parent's device. This ensures that the parent has network connectivity for accessing work-related information, participating in virtual meetings, or communicating with colleagues. The teenager, who may have other means of communication, can manage without the eSIM temporarily.

Additionally, consider a scenario where a family is going on a trip, and the family members are initially staying together but will eventually move apart. For example, the family may travel together to a theme park, but the children may split off to different attractions while the parents stay together. In this case, the system can prioritize the eSIM transfer to the device of the child who will be moving apart from the group. This ensures that the child has reliable network access for safety and communication, while the parents, who are staying together, can manage with other communication means.

By leveraging the movement patterns of the electronic devices as a determining factor for eSIM transfer priority, the system can dynamically manage network connectivity in a way that enhances safety, communication, and convenience for family members. This approach reduces the need for manual intervention and ensures that the devices requiring the most immediate access to network services receive priority, thereby improving the overall user experience within a family setting.

In still other embodiments, determining the priority of which electronic device leaving the trusted location receive the eSIM at step 404 can, in one embodiment, be determined as a function of manual definitions 704 made by a user using a user interface or controls. This approach allows users to manually set priority rules and preferences for eSIM transfers based on their specific needs and circumstances.

The user interface or controls provide a platform for users to define and customize the priority settings, ensuring that the eSIM is allocated to the most appropriate device when multiple devices are leaving the trusted location. The user interface can include various options and settings that allow users to specify priority criteria. For example, users can assign priority levels to each device based on factors such as the user's age, the importance of the destination, or the need for continuous network connectivity.

The interface can also provide options for users to create custom rules and conditions for eSIM transfers. These rules can be based on specific scenarios, such as prioritizing a child's device when they are going to school or a parent's device when they are attending a business meeting. The controls can include sliders, checkboxes, dropdown menus, and other interactive elements that enable users to easily adjust and configure the priority settings.

Users can also set default priority levels for each device, which the system will use when no specific conditions are met. Additionally, the interface can provide real-time feedback and notifications to inform users about the current priority status and any upcoming eSIM transfers. By leveraging manual definitions 704 through a user interface or controls, the system ensures that the eSIM is allocated according to the user's preferences and requirements. This approach enhances the flexibility and customization of eSIM management, allowing users to tailor the system to their family dynamics and communication needs. The manual definitions 704 provide a user-friendly and intuitive way to manage eSIM transfers, reducing the need for manual intervention and ensuring seamless network connectivity for the devices that need network connectivity most.

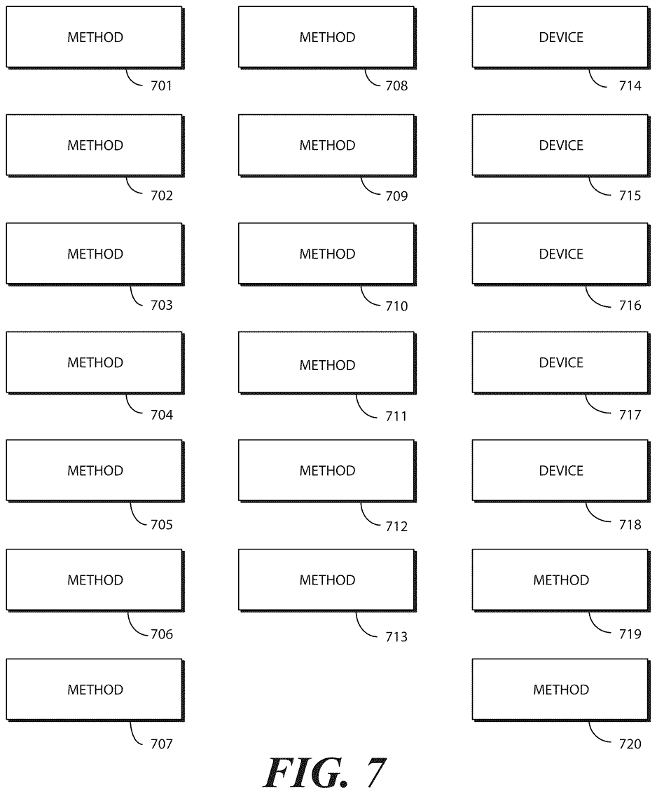

Turning now back to FIG. 7, in one or more embodiments step 405 initiates a seamless transfer of the eSIM configuration from the first device to the priority device. In one or more embodiments, this transfer process involves updating the eSIM profile on the priority device, allowing the priority device to connect to the mobile network. The system ensures that the transfer is smooth and does not require manual intervention from the user. This step is necessary for maintaining continuous network connectivity for the priority device as the priority device leaves the trusted location.

In one or more embodiments, step 406 then authenticates the transfer request on the priority device. This authentication process verifies that the transfer request is legitimate and authorized. Once the verification is successful, the system completes the eSIM transfer process. The priority device is now configured with the eSIM and can operate on the mobile network. This step ensures that the eSIM transfer is secure and that only authorized devices can receive the eSIM configuration.

In one or more embodiments, decision 407 continues to monitor the status of the priority device. The decision 407 checks if the priority device returns to the trusted location. This decision point is for managing the eSIM configuration dynamically. If the priority device returns to the trusted location, the system can initiate another transfer of the eSIM back to the default device or another appropriate device within the trusted location at step 408.

In one or more embodiments, if the priority device returns to the trusted location, the system seamlessly transfers the eSIM configuration back to the default device at step 408. This step 408 involves updating the eSIM profile on the default device, allowing the default device to reconnect to the mobile network. The system ensures that the transfer is smooth and does not disrupt the network connectivity of the devices within the trusted location. This step is necessary for maintaining efficient management of the eSIM among the family devices.

If the priority device does not return to the trusted location, the system continues to operate the eSIM in the priority device at step 409. The eSIM remains active on the priority device, allowing the priority device to maintain network connectivity while away from the trusted location. The system ensures that the eSIM configuration is dynamically managed based on the location and movement of the dependent devices within the family. This step reduces the need for manual intervention and provides seamless connectivity for the devices that need network connectivity.

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic communication device comprises determining, by one or more processors of the electronic communication device, that a communication device of the electronic device is operable with an eSIM having at least a first profile associated with the electronic communication device and at least a second profile associated with at least a second electronic communication device while the eSIM is operating with the first profile in a trusted location. At 701, the method comprises determining, by the one or more processors from signals received by the communication device from the second electronic communication device, that the second electronic communication device is departing the trusted location. At 701, the method comprises performing, in response to the second electronic communication device departing the trusted location, a transfer of the eSIM from the electronic communication device to the second electronic communication device.

At 702, the performing of 701 comprises causing a transition of the eSIM from the first profile to the second profile. At 703, the initiating of 702 comprises receiving, by the communication device, authentication of a transfer request for the eSIM from the second electronic communication device.

At 704, the method of 702 further comprises deactivating, by the one or more processors, the eSIM at the electronic communication device once the eSIM becomes operational on the second electronic communication device. At 705, the method of claim 1 further comprises also determining, by the one or more processors from other signals received by the communication device, that the second electronic communication device is returning to the trusted location. At 705, the method comprises initiating, in response to the second electronic communication device returning to the trusted location, another transfer of the eSIM from the second electronic communication device to the electronic communication device.

At 706, the method of 705 further comprises authenticating, by the one or more processors, a transfer request upon verifying that a transition of the eSIM from the second profile to the first profile has occurred. At 707, the method of 706 further comprises activating, by the one or more processors, the eSIM at the electronic communication device. At 708, the signals of 701 received by the communication device from the second electronic communication device indicate that an event is occurring at a scheduled time that will cause the second electronic communication device to leave the trusted location.

At 709, the method of 701 further comprises also determining, by the one or more processors from one or more sensors of the electronic communication device, that the electronic communication device is departing the trusted location within a predefined time window during which the second electronic communication device is departing the trusted location. At 709, the method comprises obtaining, by the one or more processors from a memory of the electronic device, a prioritization schedule prioritizing the electronic communication device and the second electronic communication device. At 709, the method comprises precluding the performing of the transfer of the eSIM from the electronic communication device to the second electronic communication device when the electronic communication device is prioritized above the second electronic communication device.

At 710, the prioritization schedule of 709 is defined by ages of authorized users of the electronic communication device and the second electronic communication device, respectively. At 711, the prioritization schedule of 709 is a function of destination locations for the electronic communication device and the second electronic communication device.

At 712, an arrangement of the prioritization schedule of 709 depends upon whether destination locations for the electronic communication device and the second electronic communication device are the same or are different. At 713, the electronic communication device of 701 and the second electronic communication device are dependent devices from a third electronic communication device.

At 714, an electronic communication device comprises a communication device operable with an eSIM having at least a first profile associated with the electronic communication device and at least a second profile associated with at least a second electronic communication device. At 714, the electronic device comprises one or more processors operable with the communication device. At 714, the one or more processors, in response to detection of a trusted location departure event, initiate a transfer of the eSIM from the second electronic communication device to the electronic communication device.

At 715, the one or more processors of 714 only initiate the transfer of the eSIM when the trusted location departure event occurs while the eSIM is operating with the second profile at the second electronic communication device at the trusted location. At 716, the one or more processors of 715 initiate the transfer of the eSIM in accordance with a prioritization schedule defining a prioritization of the electronic communication device and the second electronic communication device.

At 717, the one or more processors of 716 initiate another transfer of the eSIM to the second electronic communication device from the electronic communication device in response to detection of a trusted location entry event. At 718, the trusted location departure event of 714 is scheduled in a calendaring application operating on the one or more processors.

At 719, a method in an electronic communication device comprises detecting, by one or more processors of the electronic communication device, that a communication device of the electronic device is operable with an eSIM having at least a first profile associated with another electronic communication device and at least a second profile associated with the electronic communication device while the eSIM is operating with the first profile in a trusted location. At 719, the method comprises determining, by the one or more processors, that the electronic communication device is departing the trusted location.

At 719, the method comprises initiating, in response to the electronic communication device departing the trusted location, a transfer of the eSIM from the another electronic communication device to the electronic communication device. At 720, the determining of 719 comprises accessing a schedule of events stored in a calendaring application operable on the one or more processors.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic communication device, the method comprising:
determining, by one or more processors of the electronic communication device, that a communication device of the electronic communication device is operable with an embedded subscriber Identity Module (eSIM) having at least a first profile associated with the electronic communication device and at least a second profile associated with at least a second electronic communication device while the eSIM is operating with the first profile in a trusted location;
determining, by the one or more processors from signals received by the communication device from the second electronic communication device, that the second electronic communication device is departing the trusted location; and
performing, in response to the second electronic communication device departing the trusted location, a transfer of the eSIM from the electronic communication device to the second electronic communication device.

2. The method of claim 1, wherein the performing comprises causing a transition of the eSIM from the first profile to the second profile.

3. The method of claim 2, wherein the performing comprises receiving, by the communication device, authentication of a transfer request for the eSIM from the second electronic communication device.

4. The method of claim 2, further comprising deactivating, by the one or more processors, the eSIM at the electronic communication device once the eSIM becomes operational on the second electronic communication device.

5. The method of claim 1, further comprising:
also determining, by the one or more processors from other signals received by the communication device, that the second electronic communication device is returning to the trusted location; and
initiating, in response to the second electronic communication device returning to the trusted location, another transfer of the eSIM from the second electronic communication device to the electronic communication device.

6. The method of claim 5, further comprising authenticating, by the one or more processors, a transfer request upon verifying that a transition of the eSIM from the second profile to the first profile has occurred.

7. The method of claim 6, further comprising activating, by the one or more processors, the eSIM at the electronic communication device.

8. The method of claim 1, wherein the signals received by the communication device from the second electronic communication device indicate that an event is occurring at a scheduled time that will cause the second electronic communication device to leave the trusted location.

9. The method of claim 1, further comprising:
also determining, by the one or more processors from one or more sensors of the electronic communication device, that the electronic communication device is departing the trusted location within a predefined time window during which the second electronic communication device is departing the trusted location;
obtaining, by the one or more processors from a memory of the electronic communication device, a prioritization schedule prioritizing the electronic communication device and the second electronic communication device; and
precluding the performing of the transfer of the eSIM from the electronic communication device to the second electronic communication device when the electronic communication device is prioritized above the second electronic communication device.

10. The method of claim 9, wherein the prioritization schedule is defined by ages of authorized users of the electronic communication device and the second electronic communication device, respectively.

11. The method of claim 9, wherein the prioritization schedule is a function of destination locations for the electronic communication device and the second electronic communication device.

12. The method of claim 9, wherein an arrangement of the prioritization schedule depends upon whether destination locations for the electronic communication device and the second electronic communication device are the same or are different.

13. The method of claim 1, wherein the electronic communication device and the second electronic communication device are dependent devices from a third electronic communication device.

14. An electronic communication device, comprising:
a communication device operable with an embedded subscriber Identity Module (eSIM) having at least a first profile associated with the electronic communication device and at least a second profile associated with at least a second electronic communication device; and
one or more processors operable with the communication device;
wherein the one or more processors, in response to detection of a trusted location departure event, initiate a transfer of the eSIM from the second electronic communication device to the electronic communication device.

15. The electronic communication device of claim 14, wherein the one or more processors only initiate the transfer of the eSIM when the trusted location departure event occurs while the eSIM is operating with the second profile at the second electronic communication device at a trusted location associated with the trusted location departure event.

16. The electronic communication device of claim 15, wherein the one or more processors initiate the transfer of the eSIM in accordance with a prioritization schedule defining a prioritization of the electronic communication device and the second electronic communication device.

17. The electronic communication device of claim 16, wherein the one or more processors initiate another transfer of the eSIM to the second electronic communication device from the electronic communication device in response to detection of a trusted location entry event.

18. The electronic communication device of claim 14, wherein the trusted location departure event is scheduled in a calendaring application operating on the one or more processors.

19. A method in an electronic communication device, the method comprising:
detecting, by one or more processors of the electronic communication device, that a communication device of the electronic communication device is operable with an embedded subscriber Identity Module (eSIM) having at least a first profile associated with another electronic communication device and at least a second profile associated with the electronic communication device while the eSIM is operating with the first profile in a trusted location;
determining, by the one or more processors, that the electronic communication device is departing the trusted location; and
initiating, in response to the electronic communication device departing the trusted location, a transfer of the eSIM from the another electronic communication device to the electronic communication device.

20. The method of claim 19, wherein the determining comprises accessing a schedule of events stored in a calendaring application operable on the one or more processors.
